(19) United States
(12) Patent Application Publication
(10) Pub. No.: US 2026/0145814 A1
(43) Pub. Date: May 28, 2026

(54) ASSESSING PERFORMANCE OF AIRCRAFTS

(71) Applicant: Honeywell International Inc., Charlotte, NC (US)

(72) Inventors: Kalimulla Khan, Bangalore (IN); Subhransu Sahoo, Bengaluru (IN); Srilakshmi Kurudi, Bangalore (IN); Ravish Udupa, Bangalore (IN)

(21) Appl. No.: 19/183,538

(22) Filed: Apr. 18, 2025

(30) Foreign Application Priority Data
Nov. 25, 2024 (IN) 202411091625

(51) Int. Cl. B64F 5/60; G07C 5/00; G07C 5/08; G08G 5/34

(52) U.S. Cl. CPC B64F 5/60; G07C 5/006; G07C 5/0808; G08G 5/34

(57) ABSTRACT

An example method for assessing performance of an aircraft includes: obtaining, by one or more processors, flight data from one or more aircraft sensors, the flight data associated with a flight operation of an aircraft; extracting, by the one or more processors, from the flight data, one or more flight data indicators, wherein each of the one or more flight data indicators represent performance of the aircraft during one or more flights; correlating, by a machine learning model, the one or more flight data indicators with one or more operational factors; generating, by the machine learning model, a custom performance model for the aircraft based on the correlating of the one or more flight data indicators with the one or more operational factors; and outputting, by the one or more processors, a performance factor for the aircraft based on the custom performance model.

This application claims the benefit of IN Provisional Patent Application No. 202411091625, filed 25 Nov. 2024, the entire contents of which is incorporated herein by reference.

### TECHNICAL FIELD

The techniques of this disclosure relate to processes, systems, and techniques for analyzing the performance of aircraft.

### BACKGROUND

Aircraft performance is a complex interplay of various factors that may significantly impact operation. These factors may be broadly categorized into: load, number of cycles, weather, structural issues, wear and tear, stresses and G's, and crew handling. For example, the more weight an aircraft carries, the more fuel the aircraft will consume.

### SUMMARY

Flight management systems (FMS) are essential tools for pilots, providing important information for flight planning and execution. However, discrepancies between predicted and actual flight parameters may lead to safety issues and operational inefficiencies. The FMS typically relies on mathematical models to predict flight parameters. These models may not be perfectly accurate, especially in varying weather conditions, air traffic congestion, or unexpected aircraft performance issues. The FMS also relies on accurate input data, such as wind forecasts, aircraft performance data, and airport information. Inaccurate or outdated data may lead to incorrect prediction. Even with advanced technology, human error can still occur. Pilots may input incorrect data or make incorrect assumptions, leading to discrepancies between predicted and actual flight parameters. Airframe repairs and inspections may include checking the structural integrity of the fuselage, wings, and other components of the aircraft.

The disclosure describes techniques that enable combining the original performance data provided by the manufacturer with actual flight data. A machine learning model may be developed that relates aircraft performance to various operational factors. The disclosed machine learning techniques may train the model on historical flight data. These techniques may consider a number of operational factors, including, but not limited to: a number of cycles, a type of landing, a type of airport, weather conditions experienced during flight, a load factor, or hours of flight.

In one example, the disclosed machine learning model may learn from historical data to predict fuel consumption more accurately based on specific operating scenarios. The disclosed model may capture the complex interactions between various factors affecting fuel burn. The disclosed system may update the aircraft performance database based on real-world data collected from the specific aircraft. For example, the disclosed system may create individualized performance profiles for each aircraft based on unique operational history of the aircraft.

According to an example of the present disclosure, a computer-implemented method for assessing performance of an aircraft includes: obtaining, by one or more processors, flight data from one or more aircraft sensors, the flight data associated with a flight operation of an aircraft; extracting, by the one or more processors, from the flight data, one or more flight data indicators, wherein each of the one or more flight data indicators represent performance of the aircraft during one or more flights; correlating, by a machine learning model, the one or more flight data indicators with one or more operational factors; generating, by the machine learning model, a custom performance model for the aircraft based on the correlating of the one or more flight data indicators with the one or more operational factors; and outputting, by the one or more processors, a performance factor for the aircraft based on the custom performance model.

According to another example of the present disclosure, a system for assessing performance of an aircraft includes: a memory; and processing circuitry coupled to the memory and configured to: obtain flight data from one or more aircraft sensors, the flight data associated with a flight operation of an aircraft; extract from the flight data, one or more flight data indicators, wherein each of the one or more flight data indicators represent performance of the aircraft during one or more flights; correlate, by a machine learning model, the one or more flight data indicators with one or more operational factors; generate, by the machine learning model, information related to the performance of the aircraft based on the correlating of the one or more flight data indicators with the one or more operational factors; and output the information generated by the machine learning model.

According to yet another example of the present disclosure, non-transitory computer-readable storage media having instructions encoded thereon, the instructions configured to cause processing circuitry to: obtain flight data from one or more aircraft sensors, the flight data associated with a flight operation of an aircraft; extract from the flight data, one or more flight data indicators, wherein each of the one or more flight data indicators represent performance of the aircraft during one or more flights; correlate, by a machine learning model, the one or more flight data indicators with one or more operational factors; generate, by the machine learning model, information related to the performance of the aircraft based on the correlating of the one or more flight data indicators with the one or more operational factors; and output the information generated by the machine learning model.

The details of one or more examples of the disclosure are set forth in the accompanying drawings and the description below. Other features, objects, and advantages will be apparent from the description, drawings, and claims.

### BRIEF DESCRIPTION OF DRAWINGS

FIG. 1 shows a system for uploading flight data to a server system in accordance with the techniques of this disclosure.

FIG. 2 is a block diagram illustrating an example machine learning model for aircraft performance predictions in accordance with the techniques of this disclosure.

FIG. 3 is a block diagram illustrating an example customized aircraft performance model in accordance with the techniques of this disclosure.

FIG. 4 is a block diagram illustrating applications of the customized aircraft performance model in accordance with the techniques of this disclosure.

FIG. 5 depicts a flowchart illustrating a method for assessing performance of an aircraft, in accordance with the techniques of the present disclosure.

FIG. 6 shows an example of an avionics system in accordance with techniques of this disclosure.

### DETAILED DESCRIPTION

Flight management systems (FMS) are essential tools for pilots, providing important information for flight planning and execution. However, discrepancies between predicted and actual flight parameters may lead to safety issues and operational inefficiencies. The FMS typically relies on mathematical models to predict flight parameters. These models may not be perfectly accurate, especially in varying weather conditions, air traffic congestion, or due to unexpected aircraft performance issues. The FMS also relies on accurate input data, such as wind forecasts, aircraft performance data, and airport information. Inaccurate or outdated data may lead to incorrect predictions. Even with advanced technology, human error can still occur. Pilots may input incorrect data or make incorrect assumptions, leading to discrepancies between predicted and actual flight parameters.

In addition, over time, aircraft components experience wear and tear, which may affect performance of the aircraft. Wear and tear may lead to changes in fuel consumption, flight speed, and other factors that influence FMS predictions. An aircraft may have sustained damage or undergone repairs that have altered original performance characteristics of the aircraft. Individual components such as, but not limited to, engines, airframes, and avionics may exhibit performance degradation due to age-related factors. FMS models may not accurately capture the performance changes that occur in older aircraft over time. FMS models may not adequately account for the cumulative effects of environmental factors such as, but not limited to, temperature, humidity, and wind conditions on aircraft performance. Different pilots may have varying flying styles and techniques that may impact fuel consumption and flight times. Air traffic control delays or re-routings may affect flight times and fuel usage. Unforeseen weather events may alter flight paths and increase fuel consumption. The FMS may be using outdated or inaccurate data about the performance characteristics of the aircraft. Errors in weather forecasts or other environmental data may lead to inaccurate predictions.

Many airlines report inconsistencies between the FMS predictions (e.g., fuel consumption, arrival time) and the actual flight parameters for older aircraft. These discrepancies are typically a few hundred kilograms of fuel or a few minutes in arrival time, respectively. Interestingly, not all airlines experience the aforementioned issue to the same extent. Airlines with more rigorous flight planning processes may be more likely to anticipate and minimize discrepancies.

Flight planning and optimization may involve factors like using historical data and performance trends of specific aircraft for more accurate fuel planning. Flight planning and optimization may also involve adjusting flight profiles based on weather forecasts and air traffic control expectations. Airlines with comprehensive training programs on FMS usage and fuel management techniques may see pilots adjust for potential discrepancies. Airlines with proactive maintenance schedules may experience less performance degradation in older aircraft, leading to more accurate FMS predictions. Airlines that prioritize data quality and ensure their FMS systems have the up-to-date information on older aircraft performance may see fewer discrepancies. Maintaining data accuracy may include regularly updating aircraft performance data based on maintenance records and flight logs. Maintaining data accuracy may also include verifying the accuracy of environmental data like weather forecasts used by the FMS. Airlines with a strategy of selectively operating older aircraft on shorter, more predictable routes may see less impact from performance inconsistencies. Airlines that regularly retire older aircraft may not experience the cumulative performance degradation and thus may have fewer discrepancies.

The region where an aircraft operates may influence performance as well. For example, high-altitude airports or regions with extreme weather conditions may result in different fuel consumption patterns compared to low-altitude regions with moderate climates. Temperature, humidity, and wind conditions vary seasonally, affecting aircraft performance. For instance, colder temperatures may lead to increased fuel consumption due to denser air. Factors like wind shear, temperature gradients, and air traffic congestion may vary throughout the day, impacting flight paths and fuel usage.

As noted above, the accuracy of the aircraft performance database may be important for accurate FMS predictions. Errors or inconsistencies in the data may lead to discrepancies. Regular updates to the performance database may be essential to reflect changes in aircraft performance due to aging, modifications, or component replacements. The models currently used to create the aircraft performance database/model may not fully capture all the nuances of aircraft performance, especially in unique operating conditions or for older aircrafts. Different pilots may have varying flying styles and techniques that may impact fuel consumption and flight times. Delays, re-routings, and other Air Traffic Controller (ATC)-related factors may affect flight paths and fuel usage. The overall condition of the aircraft, including maintenance history and component replacements, may also influence performance of the aircraft. By considering the aforementioned factors, airlines may ensure that the aircraft performance model is regularly updated with accurate data, including, but not limited to, information on regional factors, seasonal variations, and maintenance history. Airlines may collect and analyze data on flight operations to identify patterns and trends that may be affecting FMS predictions.

Aircraft manufacturers typically provide customers with performance data for each aircraft model. The performance database may consider factors like aircraft type and configuration, such as engine specifications, wing design, weight limitations, etc. The performance database may also include standard operating conditions, such as fuel burn rates, climb profiles, cruise speeds, etc., under typical conditions. This data is typically derived from wind tunnel testing, flight testing, performance calculations, and other such sources. In other words, flight conditions may be simulated in a controlled environment to measure aerodynamic characteristics, for example. Performance data may also be collected during actual flights under various conditions. Performance calculations may include, for example, using mathematical models to predict aircraft performance based on known parameters. These performance models provided by aircraft manufacturers may be generally accurate for new and slightly used aircraft. However, as aircrafts accumulate flight hours, the performance of each aircraft may deviate from the original models due to several factors, including, but not limited to: wear and tear, structural changes and operational factors.

While older aircrafts may have accumulated more wear and tear, the rate of deterioration may be significantly influenced by usage and environmental factors. Aircrafts that undergo multiple takeoffs and landings per day (e.g., short-haul flights) experience more stress on components like engines, tires, and landing gear. This may lead to faster wear and tear.

The FMS often uses a simplified approach to account for aircraft aging, typically involving a single factor, like a “fuel flow factor,” that adjusts fuel flow based on the age of the aircraft. However, aircraft performance does not necessarily degrade linearly with age. Factors like operating conditions, maintenance history, and specific component wear can significantly influence fuel consumption. Each aircraft has a unique history and experiences different operating conditions. The aforementioned factors may have a more significant impact on fuel consumption than just age alone. A single aging factor may not adequately capture the specific performance characteristics of a particular aircraft. The performance database may not capture the nuances of real-world operation, such as variations in altitude, temperature, or runway length.

The total number of hours an engine has been in operation may be a significant factor in performance of the engine. Over time, components may wear out, leading to reduced efficiency and increased fuel consumption. The number of times an engine has been started and stopped (cycles) also contributes to wear and tear. Each cycle subjects the engine to stress, which may accelerate component degradation. The environment in which an aircraft operates may have an important impact on engine performance and life as well. Ingestion of dust, sand, or other debris may cause premature wear and damage to engine components. Extreme temperatures and humidity may affect engine performance and fuel consumption. Operating at high altitudes may lead to increased engine stress and fuel consumption. Frequent takeoffs and landings may subject an engine to significant stress, particularly during the acceleration and deceleration phases. Engine deterioration may lead to increased fuel consumption due to reduced efficiency and increased internal friction. As an engine ages, power output of the engine may decrease, affecting takeoff performance, climb rate, and cruise speed. Older engines may be more prone to breakdowns or malfunctions, which may disrupt flight operations.

This disclosure describes techniques that implement a flight data-based computing module that addresses the limitations of conventional aircraft performance models. This disclosure describes a system configured to collect more detailed operational data from aircraft, including, but not limited to, flight parameters, route information, and maintenance history. Flight parameters may include, but are not limited to, altitude, temperature, fuel flow, and other relevant data points for each flight. Route information may include, but is not limited to, specific routes flown, air traffic control interactions, and any deviations from planned paths. Maintenance history may include, but is not limited to, records of repairs, replacements, and any modifications that may affect performance. The disclosed techniques may use data analytics tools to identify relationships between operational conditions and performance degradation. In one example, the disclosed machine learning model may learn from historical data to predict fuel consumption more accurately based on specific operating scenarios. The disclosed model may capture the complex interactions between various factors affecting fuel burn. The disclosed system may update the aircraft performance database based on real-world data collected from the specific aircraft. For example, the disclosed system may create individualized performance profiles for each aircraft based on unique operational history of the aircraft. The disclosed system may continuously update the aircraft performance model with new data to reflect the ongoing wear and tear of the aircraft. By moving beyond a one-size-fits-all approach and incorporating real-world operational data, the disclosed techniques may improve the accuracy of FMS predictions especially for older aircrafts. Advantageously, more accurate fuel predictions may enable aircraft to carry less fuel, thereby reducing aircraft weight, which can help airlines fuel consumption and save on the cost of fuel. Lower fuel consumption may also translate to lower carbon emissions.

As will be described in more detail below, the flight-based computing module may augment Original Equipment Manufacturer (OEM) models and may also build and train a machine learning model (e.g., a relational model). The techniques of this disclosure enable combining the original performance data provided by the manufacturer with actual flight data. A machine learning model may be developed that relates aircraft performance to various operational factors. The disclosed machine learning techniques may train the model on historical flight data. These techniques may consider a number of operational factors, including, but not limited to: a number of cycles, a type of landing, a type of airport, weather conditions experienced during flight, a load factor, or hours of flight. The number of cycles factor may indicate a frequency of takeoffs and landings. The type of landing factor may indicate runway conditions and landing technique. The type of airport factor may indicate altitude, temperature, and wind conditions of the airport.

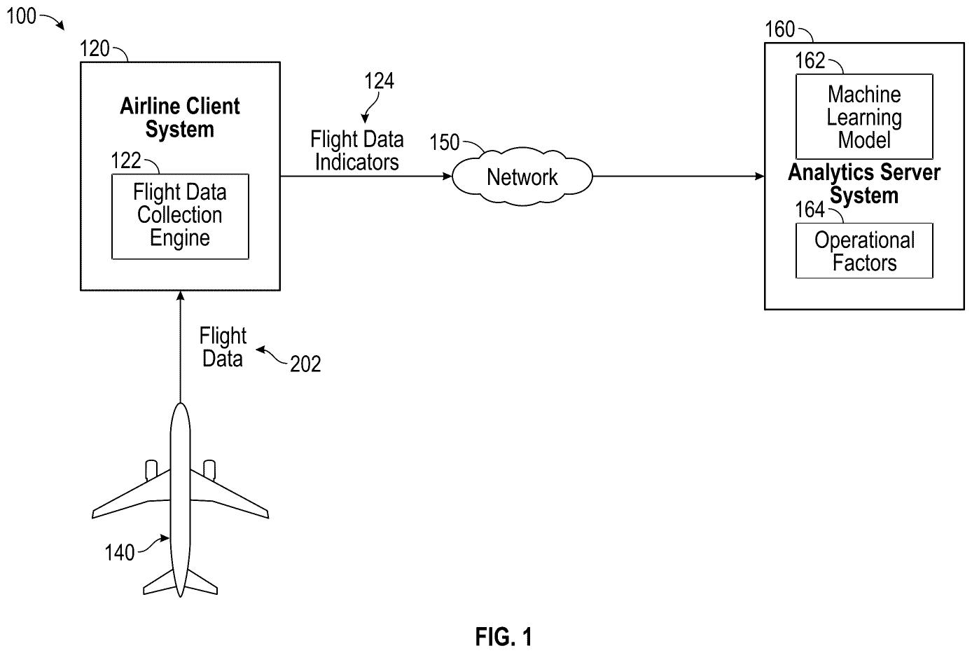

FIG. 1 shows a system 100 for uploading flight data to a server system in accordance with the techniques of this disclosure. System 100 may include client system 120, airplane 140, and server system 160. Client system 120 may, for example, be hosted and managed by an airline or other owner of aircrafts. Client system 120 may receive flight data 202 for a flight from airplane 140. The flight day may include both flight identification data and parameter data. The flight identification data may include, for example, times and dates for the flight, names of pilots, a flight number, a plane identification number, or any other such information and may be acquired from airplane 140 or from some other source.

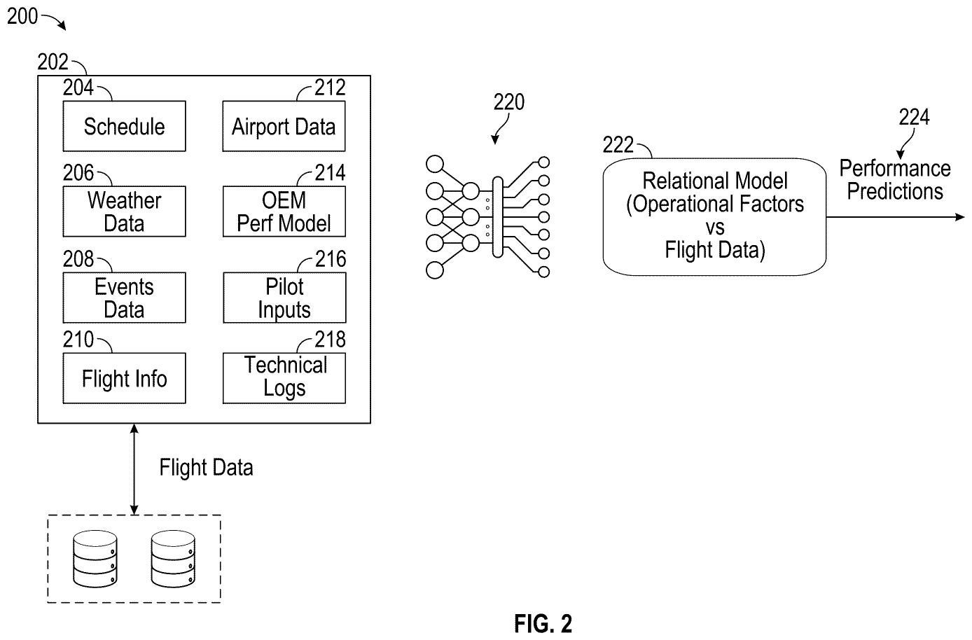

The parameter data may, for example, be data obtained from one or more sensors (e.g., a flight data recorder, such as a quick access recorder) of airplane 140 and may include values for a plurality of parameters, with each parameter being associated with a status of the aircraft and each of the values being associated with a timestamp. The parameter data may, for example, be in an ARINC 400 series format, such as ARINC 429, or an ARINC 700 series format, such as ARINC 702, 717, or 767. The parameter data may, for example, include weather data 206 shown in FIG. 2. In another example the parameter data may include any unusual occurrences or maintenance issues. Examples of parameters may further include load factor, hours of flight, and numerous other potential parameters.

Airlines typically use a process called load factor planning to determine the optimal aircraft type for specific routes based on passenger demand. Airlines may use historical data, market trends, and future projections to estimate passenger demand for each route. Based on the forecasted demand, airlines may select the most suitable aircraft type. Factors considered for aircraft selection may include, but are not limited to: capacity, range and operating costs. Capacity may indicate the number of passengers the aircraft may accommodate. The range factor may represent the distance the aircraft may fly without refueling. The operating costs factor may represent the cost of operating the aircraft, including, but not limited to, fuel, maintenance, and crew salaries. Once the aircraft type is selected, airlines may create flight schedules, considering factors like, but not limited to: departure and arrival times, frequency and route network. Airlines typically desire to align the departure and arrival times with passenger preferences and airport congestion. Airlines may determine the desirable number of flights per week. Airlines may also connect a route to other destinations in the network of the airline.

Client system 120 may be configured to store and execute flight data collection engine 122. Flight data collection engine 122 may be configured to collect the flight data 202 from various sources, such as, but not limited to, flight recorders (black boxes), sensors, and performance monitoring systems. Client system 120 may transmit, via network 150 for example, the flight data 202 to analytics server system 160. Client system 120 may also receive, via network 150, flight analysis data for the flight data 202 from server system 160, and flight data collection engine 122 may associate the flight analysis data with the flight.

The analytics server system 160 may include, for example, a machine learning model 162. As an example, the machine learning model 162 may comprise the relational model that may provide more precise estimates of aircraft performance by incorporating real-world data. As an example, machine learning model 162 may be updated regularly to reflect changes in aircraft condition and operating conditions.

Each aircraft may have its own unique performance profile based on specific history of the aircraft. Airlines could make more informed decisions regarding, for example, fuel planning, scheduling, and maintenance.

Once the machine learning model 162 is trained on historical flight data 202, the machine learning model 162 may be used to: monitor performance deterioration, predict future performance, and provide customized performance models. The machine learning model 162 may, for example, continuously track changes in aircraft performance over time. Machine learning model 162 may forecast potential performance issues based on current trends and operational factors 164.

In one example, historical flight data 202 provided by flight data collection engine 122 may include, but is not limited to, flight paths, altitude and speed, fuel consumption, engine performance metrics, weather data 206, maintenance records, pilot information. Machine learning model 162 may be trained to identify key features that may influence aircraft performance, such as, but not limited to: age of the aircraft, engine hours, component wear, operating conditions (e.g., altitude, temperature, humidity), pilot experience and maintenance history. In various implementations a suitable machine learning algorithm may be chosen for the machine learning model 162 based on the nature of the data and the desired prediction task. Some examples of potential machine learning model 162 include, but are not limited to, regression models (e.g., linear regression, random forest), time series models (e.g., AutoRegressive Integrated Moving Average (ARIMA), Long Short-Term Memory (LSTM)), neural networks. The collected data may be used to train the machine learning model 162, teaching the machine learning model 162 to recognize patterns and relationships between the features and the target variable (e.g., fuel consumption). The accuracy of the machine learning model 162 may be evaluated using appropriate metrics (e.g., mean squared error, R-squared) on a holdout dataset. Once the performance of the model reaches a desirable level, the machine learning model 162 may be used to provide more accurate predictions. More accurate predictions may help optimize flight planning and may reduce fuel consumption. Identifying potential issues early may help prevent breakdowns and reduce maintenance costs. Lower fuel consumption may contribute to reduced carbon emissions.

In an aspect of the present disclosure, the analytics server system 160 may continuously monitor actual flight data 202 provided by flight data collection engine 122 to update and refine the machine learning model 162. In an example, the analytics server system 160 may integrate weather updates and other real-time information for more dynamic predictions.

In an aspect, the machine learning model 162 may precisely predict fuel consumption, ensuring that aircrafts carry neither excess nor insufficient fuel. The disclosed machine learning model 162 may help maintain accurate schedules by accounting for potential performance variations. The machine learning model 162 may identify optimal flight routes and operating conditions to minimize wear and tear on the aircrafts. Minimizing excess fuel may reduce fuel expenses. Lower fuel consumption may lead to reduced carbon emissions. More accurate predictions enable airlines to optimize resource allocation and reduce delays. By identifying improved operating conditions, airlines may extend the useful life of their aircrafts.

In summary, historical flight data 202 for individual aircraft (tails) may be used to train the machine learning model 162, such as linear regression (as mentioned above, or potentially other algorithms like random forests or neural networks). The machine learning model 162 may consider various operational factors 164 that may influence fuel consumption and arrival time, including, but not limited to: aircraft characteristics (engine type, age, wear and tear), route details (distance, altitude, wind patterns), operating conditions (time of day, season, temperature) and pilot experience (optional, depending on data availability). Once trained, the machine learning model 162 may predict: 1) required fuel for a specific route and operating conditions; 2) estimated time of arrival (ETA) based on predicted fuel burn and flight parameters. Precise fuel predictions may help airlines avoid carrying excess fuel, reducing costs and emissions. Accurate ETAs may enable airlines to create more reliable schedules and minimize delays. Advantageously, machine learning model 162 may also be used to generate tail-specific aircraft performance models, which may be more accurate than generic aircraft performance models as the tail-specific models may account for the unique characteristics of each aircraft. The machine learning model 162 may be continuously updated with new data, allowing for adjustments based on changing conditions.

FIG. 2 is a block diagram illustrating an example machine learning model for aircraft performance predictions in accordance with the techniques of this disclosure.

In accordance with the techniques of this disclosure, machine learning model 162 shown in FIG. 1 may be implemented as a relational model 222 trained to correlate flight data 202 with operational factors 164. In an aspect, relational model 222 may be configured to process flight data 202 collected by flight data collection engine 122 from various sources, such as, but not limited to, flight recorders (black boxes), sensors, and performance monitoring systems. As shown in FIG. 2, flight data 202 may include, but is not limited to:
schedule data 204, weather data 206, events data 208, flight info 210, airport data 212, OEM performance model 214, pilot inputs 216 and technical logs 218.

In an aspect, schedule data 204 (also referred to as schedule(s) 204 herein) may include flight schedules and/or maintenance schedules. Airlines typically create flight schedules (rosters) with specific aircrafts assigned to each leg, considering operational factors 164 such as, but not limited to: demand, aircraft availability and aircraft type. The demand factor may indicate passenger and cargo load factors on each route. The aircraft availability factor may indicate availability of aircraft based on maintenance schedules and operational needs. The aircraft type factor may match the right aircraft size and capacity to the demand on each route. In one non-limiting example, the relational model 222 may be used to predict the fuel consumption for each leg of the planned flight based on factors such as: aircraft characteristics (tail number), route details (distance, altitude, weather forecast) and operational conditions (time of day, season).

In one example, the performance predictions 204 (e.g., predicted fuel consumption data) generated by relational model 222 may be integrated into a rostering system (not shown in FIG. 2). Such integration may allow for assigning an aircraft to routes where the predicted fuel burn may be optimized. The aforementioned integration may also allow the rostering system to select the suitable aircraft for each route based on current performance of the corresponding aircraft. Lowering fuel consumption may lead to lower emissions. The disclosed techniques may enable the rostering system to adjust schedules 204 based on any significant deviations from predicted performance of a particular aircraft.

The following are some benefits of integrating the relational model 222 with the rostering system. More accurate fuel predictions may lead to improved fuel use and cost savings. Matching aircraft performance to specific routes may allow for more efficient resource allocation. Lower fuel consumption may contribute to environmental sustainability. Various scheduling adjustments based on performance data may reduce scheduling disruptions.

The weather data 206 may identify weather conditions experienced during a flight, such as, but not limited to, temperature, wind, precipitation, and turbulence during a flight.

In an aspect, events data 208 may be a subset of flight data 202 that specifically captures incidents or occurrences that deviate from the normal course of a flight. These events can include: takeoff and landing events, in-flight events, safety-related events, emergency events, and the like. Takeoff and landing events may include issues related to takeoff or landing, such as aborted takeoffs, runway incursions, or landing gear malfunctions. In-flight events may include incidents that occur during the flight, such as turbulence, bird strikes, or engine failures. Safety-related events may include any event that poses a potential threat to the safety of the aircraft, crew, or passengers. Emergency events may include situations that require immediate action, such as, but not limited to, medical emergencies, hijackings, or acts of terrorism. Events may be recorded with precise timestamps to accurately track their sequence and duration. Each type of event may be assigned a unique code or identifier for easy categorization and analysis.

In an aspect, flight info 210 may include various details about a specific flight, such as, but not limited to: flight number, aircraft type, scheduled departure and arrival times, actual departure and arrival times, route, crew information, and passenger information. The flight number may be a unique identifier assigned to each flight. The aircraft type may be the model of aircraft used for the flight. The scheduled departure and arrival times may specify the planned times for takeoff and landing. The actual departure and arrival times may specify the actual times when the flight took off and landed. The route may include the specific path taken by the flight, including waypoints and altitude information. The crew information may include details about the pilots and cabin crew members on the flight. The passenger information may include basic details about the passengers on board, such as, but not limited to their names and ticket numbers.

In an aspect, airport data 212 may provide valuable insights into various aspects of aviation operations. Some examples of airport data 212 that may be included in flight data 202 may include, but are not limited to: an airport code, an airport name, a location, runway information, terminal information, air traffic control facilities, airport fees and charges. The airport code may include a unique identifier assigned to each airport, such as International Air Transport Association (IATA) code (e.g., JFK) or International Civil Aviation Organization (ICAO) code (e.g., KJFK). The airport name may be the official name of the airport. The location may include the geographic coordinates of the airport, including latitude and longitude. The runway information may include details about the runways available at the airport, including, but not limited to, length, width, and surface type. The terminal information may include information about the terminals at the airport, such as the number of gates, facilities, and services available. The air traffic control facilities may include details about the air traffic control towers, approach control units, and other facilities responsible for managing air traffic in the vicinity of the airport. The airport fees and charges may include information about the fees and charges that airlines should pay to operate at the airport.

Aircraft manufacturers typically provide customers with performance data for each aircraft model, such as OEM performance model 214. The OEM performance model 214 may consider factors like aircraft type and configuration, such as engine specifications, wing design, weight limitations, etc. The OEM performance model 214 may also include standard operating conditions, such as fuel burn rates, climb profiles, cruise speeds, etc., under typical conditions. This data is typically derived from wind tunnel testing, flight testing, performance calculations, and other such sources.

Flight data recorders (FDRs) capture a variety of information about a flight, including pilot inputs 216. Pilot inputs 216 may provide valuable insights into the actions of the pilot and decisions during the flight. Pilot inputs 216 may include information such as but not limited to, control wheel and pedal positions, autopilot engagements, radio communication, etc.

In an aspect, flight data 202 may also include one or more technical logs 218. Technical logs 218 may include information such as, but not limited to, maintenance records, technical issues and defects, FDR information. The maintenance records may include details of all maintenance performed on the aircraft, including inspections, repairs, and component replacements. The technical issues and defects may include any technical problems or defects identified during pre-flight inspections, in-flight operations, or post-flight checks. Data extracted from the FDR may include flight parameters and system performance.

In an aspect, the flight data 202 may be provided in different formats, including, but not limited to, time series data, technical logs 218, and pilot inputs 216. The time series data may include data that captures information at specific timestamps throughout the flight, such as, but not limited to fuel flow, speed, altitude, and other parameters. The technical logs 218 may record technical events or faults encountered during the flight. The pilot inputs 216 may contain information documented by the pilot, such as, but not limited to, performance observations or issues experienced. Advantageously, the relational model 222 may integrate this diverse data into a single model that captures the actual performance of the aircraft. It should be noted that data integration may involve data cleaning, pre-processing, and feature engineering to ensure compatibility and to extract meaningful information from each format.

In accordance with the techniques of the present disclosure, the relational model 222 may extract specific flight data indicators 124 from flight data 202. These flight data indicators 124 may include, for example: performance metrics (e.g., engine performance, fuel consumption, airspeed, altitude, and acceleration) and maintenance data (maintenance history, component life cycles, and repair records). The relational model 222 may identify relationships between the flight data indicators 124 and operational factors 164. For example, the relational model 222 may correlate increased fuel consumption with specific weather conditions or pilot techniques. The relational model 222 may also identify unusual patterns in flight data 202, indicating potential issues or anomalies that may require further investigation.

In an aspect, the custom performance model 302 may be trained using real-world flight data 202 shown in FIG. 2 that captures the actual performance of the aircraft under various conditions. The training data set may be updated at desirable periodicity. This periodicity may be daily, weekly, monthly, or based on other relevant factors.

In an aspect, the flight data 202 may come from actual flight records. In other words, the flight data 202 may include data on flights that have already taken place.

In an aspect, the relational model 222 may be trained to compare the predicted performance (from the OEM performance model 214) with the actual performance data obtained from real flights. This comparison may help the relational model 222 identify the areas where the OEM performance model 214 may not accurately reflect the real aircraft behavior. In an aspect, the relational model 222 may consider all the factors that could have impacted the performance during the actual flight. The factors considered by the relational model 222 could include, but are not limited to: weather data 206 (wind speed, temperature, etc.), operational factors 164 (weight, altitude, flight path, etc.), aircraft specificities (age, maintenance history, etc.). In an aspect, the relational model 222 may employ multiple machine learning algorithms. The machine learning algorithms may analyze the vast amount of flight data 202 and may identify the relationships between various factors and the actual performance metrics.

In accordance with the techniques of this disclosure, the relational model 222 may determine the most suitable aircraft configuration (e.g., tail size) for specific flight sectors based on performance predictions. For example, relational model 222 may identify potential problems before the problems occur by monitoring performance trends and anomalies. In accordance with the techniques of this disclosure, the relational model 222 may improve maintenance schedules based on predicted performance degradation. The relational model 222, for example, may determine the optimal inventory levels of spare parts based on projected maintenance needs. In accordance with the techniques of this disclosure, airlines may make more informed decisions regarding fuel planning, routing, and maintenance. In an example implementation, by improving operations, airlines may potentially reduce costs related to fuel consumption, maintenance, and delays. In an example implementation, accurate performance predictions may enable airlines to plan fuel loads more efficiently, reducing fuel costs and emissions.

In accordance with the techniques of the disclosure, relational model 222 may be implemented as a deep learning model. Deep learning is a specialized field within machine learning that employs artificial neural networks with multiple layers to learn complex patterns from data. These neural networks are loosely inspired by the structure and function of the human brain, but the neural networks operate on a much simpler level. An exemplary neural network 220 is illustrated in FIG. 2. Neural networks are computational models composed of interconnected nodes (neurons) organized into layers. Each neuron in neural network 220 may receive inputs, process inputs, and may produce an output. Neural networks typically have multiple layers, including, but not limited to: an input layer, hidden layers, and an output layer. The input layer may receive the raw data as input. The hidden layers may perform complex computations on the data, extracting and transforming features. The output layer may produce the final prediction or classification. Activation functions may introduce nonlinearity into the neural network 220, enabling the neural network 220 to learn complex patterns. Common activation functions include, but are not limited to, ReLU (Rectified Linear Unit), sigmoid, and tanh. The relational model 222 may be trained on large datasets using algorithms like backpropagation, which adjusts the weights of the connections between neurons to minimize the error between the predicted and actual outputs.

In an aspect, while relational model 222 may not be directly used during flight, the relational model 222 may provide valuable information for flight planning. For example, relational model 222 may be employed to determine the efficient routes based on factors like fuel consumption, air traffic, and weather data 206. Relational model 222 may also be trained to estimate arrival and departure times. Such estimations may involve predicting potential delays or disruptions. In one example, relational model 222 may analyze flight data 202 to identify areas for optimization. The relational model 222 illustrated in FIG. 2 may help improve flight operations, reduce costs, and improve safety.

In accordance with the techniques of this disclosure, precise estimates of flight times may allow for better scheduling and reduced delays. In accordance with the techniques of this disclosure, by understanding performance variations, the relational model 222 may select the most efficient routes, saving time and fuel. For example, in some implementations, early detection of performance anomalies may help identify potential maintenance issues before the maintenance issues lead to more serious problems. In accordance with the techniques of this disclosure, predictive maintenance may help schedule maintenance tasks more effectively, reducing downtime and costs.

In accordance with the techniques of this disclosure, by anticipating maintenance needs, airlines may minimize unexpected delays caused by equipment failures. In accordance with the techniques of this disclosure, a highly accurate relational model 222 may enhance the capabilities of flight management systems, leading to improved flight efficiency and safety. In this regard, in some implementations, performance predictions 224 may support efficient flight planning and dispatch, ensuring that aircrafts have sufficient fuel and arrive on time. The relational model 222 may be used for various analytical purposes, such as evaluating fuel efficiency, identifying safety risks, and analyzing operational trends.

In accordance with the techniques of this disclosure, the relational model 222 may link operational conditions of flights to the deterioration of aircraft performance. The machine learning model 222 may be trained on historical flight data 202 to identify patterns and correlations between various factors. In this regard, in some implementations, relational model 222 may gather historical flight data 202, including, but not limited to, information on operational conditions, maintenance records, and performance metrics.

In accordance with the techniques of this disclosure, analytics server system 160 may employ machine learning algorithms to train the relational model 222 that predicts aircraft performance deterioration based on the selected features. In accordance with the techniques of this disclosure, analytics server system 160 may assess the accuracy of the relational model 222 and may assess performance of the relational model 222 using appropriate metrics.

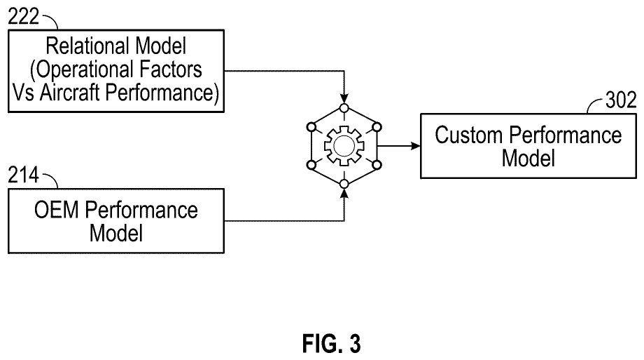

FIG. 3 is a block diagram illustrating an example customized aircraft performance model in accordance with the techniques of this disclosure.

In accordance with the techniques of the present invention, building a model for each individual aircraft (tail number) is a more personalized technique that may capture the unique characteristics and performance history of each aircraft. Each aircraft has its own history, including maintenance records, operating conditions, and pilot techniques. A tail-specific machine learning model, for example custom performance model 302 shown in FIG. 3 may account for these individual factors. By tailoring the OEM performance model 214 to a specific aircraft, more accurate predictions may be achieved as compared to a generic model OEM performance model 214. Tail-specific custom performance model 302 may help identify deviations from expected performance, potentially indicating maintenance issues or other problems. In this case, data collection may include comprehensive data for the specific tail number, including, but not limited to: flight parameters, maintenance records, operating conditions and pilot information. As noted above, the relational model 222 may extract relevant features from the collected data, considering tail-specific factors like: age of the aircraft, engine hours, component wear, operating conditions, pilot experience. A suitable machine learning algorithm (e.g., regression, time series, neural networks) may be chosen for the tail-specific custom performance model 302. Next, the tail-specific custom performance model 302 may be trained on the tail-specific data. The performance of the tail-specific custom performance model 302 may be assessed using appropriate metrics, as described above. At deployment time, the tail-specific custom performance model 302 may be integrated into the FMS to provide tail-specific predictions.

In accordance with the techniques of the present disclosure, custom performance model 302 may comprise a customized performance model. The customized performance model may be a tailored mathematical representation of the performance characteristics of the aircraft. In one example, the output of the custom performance model 302 may be loaded into a Flight Management System (FMS). The FMS is the onboard computer system that may coordinate and manage various flight parameters, including navigation, performance, and systems monitoring. In other words, the custom performance model 302 may not be a generic template but may be rather trained to accurately reflect the unique performance characteristics of a particular aircraft. The performance characteristics may include factors like engine efficiency, airframe design, and weight distribution. One of the objectives of the custom performance model 302 may be to improve flight efficiency. Custom performance model 302 may help in determining the most fuel-efficient flight paths, speeds, and altitudes, contributing to reduced fuel consumption and environmental impact.

In an aspect of the present disclosure, the OEM performance model 214 may represent the original performance data or baseline for comparison. As describe above, relational model 222 may be used to understand the factors that influence the performance of the aircraft. By analyzing the factors, the relational model 222 may predict the performance of the aircraft under various conditions. The custom performance model 302 may be derived by augmentation of OEM performance model 214 and relational model 222 and may be influenced by the factors identified in the relational model 302.

The custom performance model 302 may consider various factors that may impact the flight, such as fuel flow, speed, and weight. These factors may be captured in the relational model 222, which is used to predict performance. In an example, the custom performance model 302 may calculate fuel burn between two points during a flight. This calculation may take into account factors like standard speed and fixed weight. The custom performance model 302 may be used to estimate the fuel consumption and other performance metrics for a planned flight.

The custom performance model 302 may predict various aspects of the future performance of the aircraft, based on factors, such as, but not limited to, weight, time, speed, and altitude. In one implementation, the custom performance model 302 may employ a set of multidimensional graphs that may be provided by relational model 222 and that may represent how different aircraft parameters (like fuel flow, drag, thrust, and altitude) interact with each other. The multidimensional graphs may help visualize the complex relationships between these factors. The custom performance model 302 may also use data provided by the OEM performance model 214. In other words, the custom performance model 302 may also take into consideration specific data and knowledge about the design and characteristics of the specific aircraft.

In an example, the custom performance model 302 may be used to predict the level of deterioration for each aircraft tail based on operational factors. This information may be valuable for maintenance planning and ensuring the overall safety and reliability of the aircraft. By feeding a flight plan into the custom performance model 302, the custom performance model 302 may provide predictions about the deterioration that may occur during the flight. Such predictions may enable proactive monitoring and potential adjustments to the flight plan if necessary. As noted above, the custom performance model 302 may use a set of multidimensional graphs to visualize the relationships between different factors that influence deterioration. These multidimensional graphs may help identify potential areas of concern and may guide maintenance decisions.

In an aspect of the present disclosure, the starting point may be a basic 2D graph model provided by the OEM performance model 214. The OEM performance model 214 may represent the “ideal” performance of the aircraft under standard conditions. The custom performance model 302 may then be created by analyzing real-world data through the relational model 222. The relational model 222 may take various factors into account (e.g., operational history, environmental conditions). Based on this analysis, the relational model 222 may identify deviations from the OEM performance model 214 for specific parameters. This deviation is referred to hereinafter as “distillation.” The specific graphs in the custom performance model 302 may be updated based on the identified deviations. The aforementioned graphs may represent key performance parameters like thrust, drag, or fuel flow. This process essentially refines the OEM performance model 214 with real-world data, creating a more accurate representation of the performance of the specific aircraft.

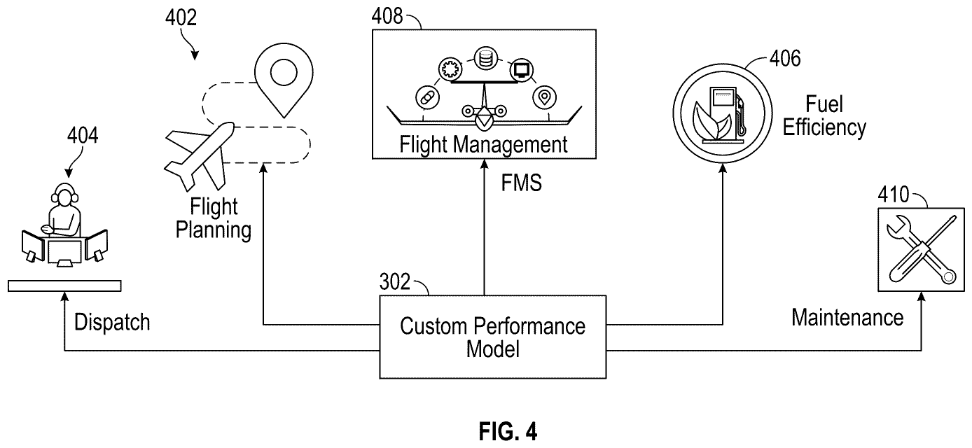

FIG. 4 is a block diagram illustrating applications of the customized aircraft performance model in accordance with the techniques of this disclosure.

As shown in FIG. 4, in some implementations, custom performance model 302 may support efficient flight planning 402 and dispatch 404, ensuring that aircrafts have sufficient fuel and arrive on time. The custom performance model 302 may be used for various analytical purposes, such as evaluating fuel efficiency 406, identifying safety risks, and analyzing operational trends.

In one example, the custom performance model 302 may consider factors like the weight, lift, and speed of the aircraft. These factors may be used by the FMS 408 to make various calculations. One exemplary calculation may involve determining the fuel consumption between two points (A and B). The custom performance model 302 may be able to predict the appropriate fuel consumption based on the current weight, speed, and wind conditions.

In an aspect, the custom performance model 302 may calculate the average fuel burn per nautical mile. This information may then be used to estimate the total fuel consumption between points A and B. The FMS 408 may use the predicted fuel burn to provide accurate predictions for flight planning 402. Flight planning 402 may include, but is not limited to estimating fuel reserves, calculating flight times, and determining optimal flight paths. In an aspect, the custom performance model 302 may be a component of the FMS 408. By accurately calculating fuel burn and other parameters, the custom performance model 302 may provide essential data for flight planning and decision-making.

It should be noted that currently, the FMS 408 may use OEM performance model 214. Advantageously, the custom performance model 302 may be created instead using a more refined techniques, incorporating real-world data and specific factors. Once the custom performance model 302 is developed, as described above, the custom performance model 302 may be loaded into the FMS 408. The disclosed techniques may enable the FMS 408 to use the more accurate and tailored performance predictions 224 provided by the custom performance model 302. The aforementioned integration may allow the FMS 408 to create more efficient routes by considering the specific capabilities of the aircraft and the current environmental conditions. The FMS 408 integrated with the custom performance model 302 may predict fuel consumption more accurately, which may lead to cost savings and reduced environmental impact. Such FMS 408 may provide more accurate information to the pilots, enabling the pilots to make more informed decisions and to avoid potential hazards. The FMS 408 integrated with the custom performance model 302 may dynamically adjust flight plans based on real-time data and the predictions of the custom performance model 302.

In an aspect the custom performance model 302 may not necessarily employ a single graph, but the model may use multiple graphs or other visualization techniques as a way to represent the “delta” between the actual performance and the OEM performance model 214. These “delta graphs” may show the differences between the predicted and observed performance for various factors across different flight conditions. Advantageously, the level of detail captured in the custom performance model 302 may be significantly higher as compared to the OEM performance model 214. The OEM performance model 214 may provide a baseline for “ideal” performance, while the custom performance model 302 may incorporate real-world variations and factors specific to a particular aircraft.

In addition, the custom performance model 302 may predict future performance based on current and historical data. For instance, the custom performance model 302 may predict potential engine failures or maintenance needs 410. In an example, the relational model 222 may recommend specific actions to improve performance, such as optimizing flight paths or adjusting maintenance schedules.

In accordance with the techniques of this disclosure, the custom performance model 302 may help anticipate maintenance needs based on operational conditions, reducing downtime and costs. For example, airlines may schedule maintenance tasks more effectively, ensuring that aircrafts remain in optimal condition.

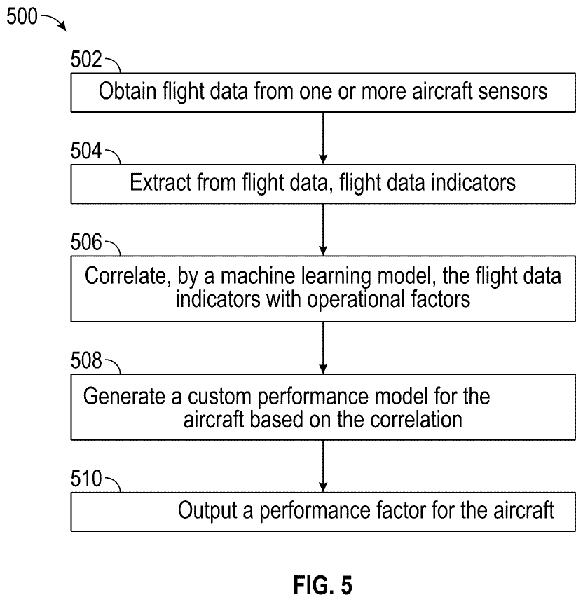

FIG. 5 depicts a flowchart illustrating a method for assessing performance of an aircraft, in accordance with the techniques of the present disclosure.

Process 500 will be described with respect to system 100, but it should be understood that other computing systems may also be configured to perform process 500. Flight data collection engine 122 may obtain flight data 202 from one or more aircraft sensors (502). The flight data 202 may be associated with a flight operation of an aircraft. In one example, historical flight data 202 provided by flight data collection engine 122 may include, but is not limited to, flight paths, altitude and speed, fuel consumption, engine performance metrics, weather data 206, maintenance records, pilot information. Next, flight data collection engine 122 may extract from the flight data 202, one or more flight data indicators 124 (504). Each of the flight data indicators 124 may represent performance of the aircraft during one or more flights. In accordance with the techniques of this disclosure, these flight data indicators 124 may include, for example: performance metrics (e.g., engine performance, fuel consumption, airspeed, altitude, and acceleration) and maintenance data (maintenance history, component life cycles, and repair records).

In accordance with the techniques of the present disclosure, the machine learning model 162 may correlate the flight data indicators 124 with one or more operational factors 164 (506). In one example, the machine learning model 162 may correlate increased fuel consumption with specific weather conditions or pilot techniques. Additionally, the machine learning model 162 may generate a custom performance model for the aircraft based on the correlating of the flight data indicators 124 with the operational factors 164 (508) and may output a performance factor for the aircraft based on the custom performance model (510). In this regard, in some implementations, performance predictions 224 may support efficient flight planning 402 and dispatch 404, ensuring that aircrafts have sufficient fuel and arrive on time. The machine learning model 162 may be used for various analytical purposes, such as evaluating fuel efficiency, identifying safety risks, and analyzing operational trends.

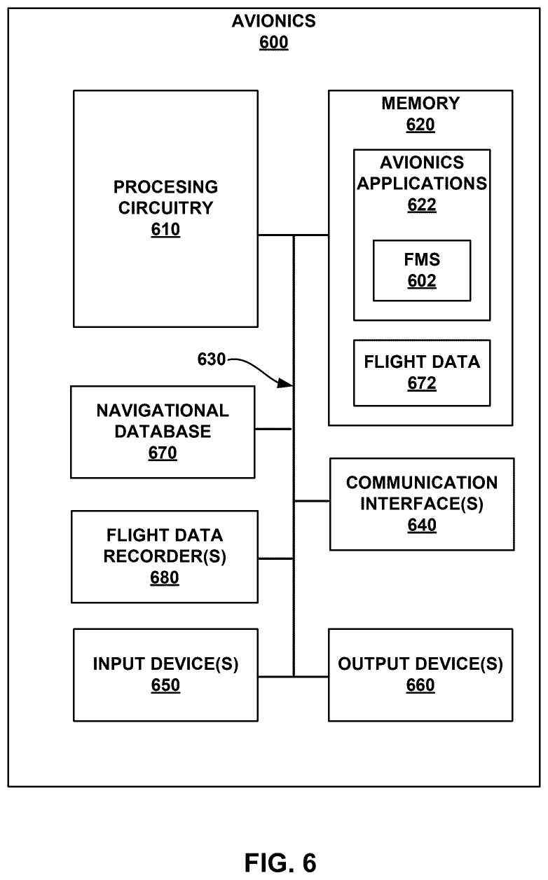

FIG. 6 illustrates an example of avionic 600. Avionics 600 is specialized computing hardware configured to store and execute avionics applications. In the example of FIG. 6, avionics 600 includes processing circuitry 610, memory 620 which stores avionics applications 622, communication interface(s) 640 to communicate with other devices, such as EFB 500, input device(s) 650, output device(s) 660, navigational database 670, and flight data recorder(s) 680. The aforementioned components of avionics 600 may be connected to one another through a bus 630, which generally represents one or more busses and is intended to generically represent all the electrical and data connectivity of internal components included within avionics 600.

Processing circuitry 610 implements the functionality of and/or executes the instructions associated with avionics applications 622. Processing circuitry 610 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware or any combinations thereof. When the techniques are implemented partially in software, avionics 600 may store instructions for the software in a suitable, non-transitory computer-readable medium (e.g., memory 620) and execute the instructions in hardware using processing circuitry 610 to perform the techniques of this disclosure.

Memory 620 is intended to generically represent all memory included within avionics 600. In some implementations, memory 620 may include a plurality of separate devices and memory units. Theses memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned avionics application (shown in FIG. 6 as avionics applications 622) may be stored in any volatile and/or non-volatile memory component of memory 620.

Communication interface(s) 640 generally represents all hardware e.g., transceiver circuitry, within avionics 600 for communicating with external devices either on the ground or while in flight. Communication interface(s) 640 may facilitate communication with external devices via one or more wired and/or wireless network connections by transmitting and/or receiving signals on the one or more networks. Examples of communication interface(s) 640 include a network interface card (e.g. such as an Ethernet card), an optical transceiver, a radio frequency transceiver, a GPS receiver, or any other type of device that can send and/or receive information. Other examples of communication interface(s) 640 may include short wave radios, cellular data radios, wireless network radios, as well as USB controllers. Examples of communication interface(s) 640 for in-flight communication include a very high frequency (VHF) radio, a high frequency (HF) radio, or a satellite communication (SATCOM) radio.

Examples of communication interface(s) 640 used for data links include an aircraft communications addressing and reporting system (ACARS) for providing a digital data link system that allows for the exchange of messages between the aircraft and ground stations for purposes such as flight plan updates, weather information, and maintenance reports. Another examples of communication interface(s) 640 used for data links include controller-pilot data link communications (CPDLC) which allows air traffic control to send instructions and receive acknowledgments from pilots via text messages. Communications interface(s) 640 may also include an automatic dependent surveillance-broadcast transponder. The various examples of communications interfaces listed above represent a non-exhaustive list of the types of the types of communication interfaces that may be included in communication interface(s) 640.

Avionics 600 also includes input device(s) 650 and output device(s) 660. Examples of input device(s) 650 include control display units (CDUs) with alphanumeric keypads or touchscreens to enter flight plans, waypoints, and other necessary data. Input device(s) 650 may also include an FMS control panel for entering information to the FMS, such as route, altitude, and speed using dedicated buttons, knobs, and touchscreen interfaces. Input device(s) 650 may also include yoke or sidestick controls as well as touchscreen interfaces. Input device(s) 650 may also include rotary knobs for setting values for altitudes, speeds, and other parameters and toggle switches for selecting modes or turning systems on and off.

Examples of output device(s) 660 may include an electronic flight instrument display to provide visual representations of flight data, including altitude, airspeed, heading, and attitude. Output device(s) 660 may also include a Heads-Up Display (HUD) that projects critical flight information onto a transparent screen in the pilot's line of sight or other cockpit displays to show navigation maps, engine parameters, system statuses, and the like. Output device(s) 660 may also include engine instrumentation displays to display data on engine performance, such as temperature, pressure, and revolutions per minute (RPMs). Output device(s) 660 may also include audio panels to relay communication from radios and alerts from systems to the cockpit. Output device(s) 660 may also include an FMS display to show flight plan information and performance data, as well as a traffic collision avoidance system (TCAS) display to alert pilots to nearby aircraft and potential collision threats.

The various examples of input and output devices listed above represent a non-exhaustive list of the types of the types of input and output devices that may be included in input device(s) 650 and output device(s) 660. Additionally, input and output functionality of avionics 600 may facilitated by external devices that are separate from input device(s) 650 and output device(s) 660. For example, EFB 500 may be configured to input data to and output data for avionics 600.

Avionics applications 622 represent a suite of software tools that may be used by a pilot in managing flight operations and managing the aircraft while in flight. Avionics applications 622 includes FMS 602 discussed above as well as other applications for communication, navigation, and monitoring within an aircraft. Avionics applications 622, for example, include applications for processing and displaying weather radar data and presenting essential flight information such as altitude, airspeed, attitude, and heading to a pilot. Avionics applications 622 also include various safety applications related to surveillance systems (e.g., transponders to communicate the aircraft's identity and altitude to air traffic control and other aircraft, such as automatic dependent surveillance-broadcast (ADS-B) systems that provide real-time data to air traffic control and other aircraft). Avionics applications 622 may also include the software to manage various emergency systems (e.g., an emergency locator transmitter, flight data recorder, and cockpit voice recorder) and cabin management systems (e.g., passenger infotainment systems and environmental control systems).

Navigational database 670 represents a specialized database that stores information needed by FMS 602 for the navigation and operation of an aircraft for purposes such as flight planning, route management, and ensuring safe navigation throughout a flight. Navigational database 670 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data defining structured flight paths in the sky, including various air routes and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. The flight data may be data regarding planned routes, altitudes, and waypoints for a specific flight. The locations of waypoints, airports, and navigational aids may, for example, be defined by geographical coordinates.

Navigational database 670 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints, and speed limits. The weather information may include relevant meteorological data that might affect flight paths, such as wind patterns or turbulence zones. Navigational database 670 may be regularly updated to reflect changes in air traffic regulations, airport information, and navigational aids to ensure pilots have current information for safe and efficient flight operations.

Although not explicitly shown in FIG. 6, avionics 600 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, avionics 600 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

Flight data recorder(s) 680 may be configured to record, and store in memory 620, flight data 682. In some examples, flight data recorder(s) 680 may have dedicated memory, meaning the memory that stores flight data 682 is separate than, for example, the memory that stores avionics applications 622. Flight data recorder(s) 680 may include any combination of one or more flight data recorders including a quick access recorder, a deployable recorder, or a combined cockpit voice recorder and flight data recorder.

Flight data recorder(s) 680 may be configured to record flight dynamics and motion data. For example, flight data recorder(s) 680 may be configured to record the aircraft's altitude above sea level (i.e., altitude), the aircraft's speed relative to the surrounding air (i.e., airspeed), the aircraft's rate of ascent or descent (i.e., vertical speed), the direction the aircraft is pointed (i.e., heading), the aircraft's nose angle up/down and bank angle left/right (i.e., pitch and roll), the aircraft's deviation from a straight path or wind drift (i.e., yaw), and the aircraft's lateral, vertical, and longitudinal acceleration.

Flight data recorder(s) 680 may also be configured to record control surfaces and positioning data. For example, flight data recorder(s) 680 may be configured to record the aircraft's aileron position for controlling roll, the aircraft's elevator position for controlling pitch, the aircraft's rudder position for controlling yaw, the aircraft's flap positions for controlling changes in lift and drag (e.g., during takeoff, landing, and approach), the aircraft's spoiler positions for reducing lift and slowing the aircraft down, or the aircraft's slat positions for providing added lift during low-speed operations.

Flight data recorder(s) 680 may also be configured to record engine parameters. For example, flight data recorder(s) 680 may be configured to record the aircraft's engine output (e.g., engine thrust or power level), the aircraft engine's core and fan shaft speeds (i.e., N1 and N2 speeds), temperature of gases exiting the engine (e.g., exhaust gas temperature (EGT)), the rate at which fuel is consumed by each engine (i.e., fuel flow rate), oil Pressure, oil temperature, and thrust level set by the pilot (e.g., throttle position).

Flight data recorder(s) 680 may also be configured to record environmental conditions data. For example, flight data recorder(s) 680 may be configured to record outside air temperature, the presence of ice on wings or other critical surfaces, storm and weather information, and wind speed and direction.

Flight data recorder(s) 680 may also be configured to record aircraft systems and equipment data. For example, flight data recorder(s) 680 may be configured to record autopilot Status, such whether autopilot is engaged and what mode (altitude hold, heading mode, etc.) is being implemented. Flight data recorder(s) 680 may also be configured to record the position of the landing gear (e.g., up, down, or transit), brake pressure or braking force applied during landing, hydraulic pressure of braking systems, and cabin altitude and pressurization levels. Flight data recorder(s) 680 may also be configured to record electrical systems status, such as voltage, current, and operational state of systems.

Flight data recorder(s) 680 may also be configured to record flight path and navigation data, such as GPS position (e.g., latitude, longitude, and altitude coordinates), horizontal track and descent/ascent angles (i.e., flight path angle and track), speed relative to the ground (i.e., groundspeed), and navigation waypoints in the flight plan.

Flight data recorder(s) 680 may also be configured to record crew inputs. For example, flight data recorder(s) 680 may be configured to record control inputs, such as a pilot's inputs on yoke/stick, rudder pedals, and throttle. Flight data recorder(s) 680 may also be configured to record status or positions of switches (e.g., fuel pumps, anti-ice). Flight data recorder(s) 680 may also be configured to record communication controls, such as transponder codes, frequency changes, and communications status.

Flight data recorder(s) 680 may also be configured to record the status of warning and alarm systems, such as the status of alarms such as stall warnings, overspeed warnings, or terrain awareness warnings. Flight data recorder(s) 680 may also be configured to record engine and system alerts, such as malfunction notifications related to engine failures, low hydraulic pressures, or other such warnings. Flight data recorder(s) 680 may also be configured to record crew announcements and chimes.

In one example, processing circuitry 610 may execute one or more machine learning models 162. As noted, the machine learning model 162 may correlate flight data 202 with operational factors 164. Additionally, the machine learning model 162 may generate information related to the performance of the aircraft (e.g., performance predictions 224) based on the correlating of the flight data indicators 124 with the operational factors 164.

The following numbered examples illustrate various aspects of the systems and techniques described above.

Example 1. A computer-implemented method for assessing performance of an aircraft includes: obtaining, by one or more processors, flight data from one or more aircraft sensors, the flight data associated with a flight operation of an aircraft; extracting, by the one or more processors, from the flight data, one or more flight data indicators, wherein each of the one or more flight data indicators represent performance of the aircraft during one or more flights; correlating, by a machine learning model, the one or more flight data indicators with one or more operational factors; generating, by the machine learning model, a custom performance model for the aircraft based on the correlating of the one or more flight data indicators with the one or more operational factors; and outputting, by the one or more processors, a performance factor for the aircraft based on the custom performance model.

Example 2. The computer-implemented method of example 1, wherein the machine learning model comprises a relational model.

Example 3. The computer-implemented method of example 1, wherein the performance factor comprises at least one of: estimated flight time of the aircraft, evaluation of fuel efficiency of the aircraft, identification of one or more safety risks of the aircraft, and analysis of operational trends of the aircraft.

Example 4. The computer-implemented method of example 1, wherein the performance factor forecasts potential aircraft performance issues based on current trends and the one or more operational factors.

Example 5. The computer-implemented method of example 1, wherein the one or more operational factors comprise one or more of a number of cycles, a type of landing, a type of airport, weather conditions experienced during flight, a load factor, or hours of flight.

Example 6. The computer-implemented method of example 1, further comprising: performing, by the one or more processors, an action related to the aircraft based on the performance factor.

Example 7. The computer-implemented method of example 6, wherein the action comprises scheduling maintenance of the aircraft.

Example 8. The computer-implemented method of example 1, further comprising: generating, by the one or more processors, using the custom performance model, a flight plan; and uploading the flight plan to a Flight Management System (FMS) of the aircraft.

Example 9. The computer-implemented method of example 1, further comprising: estimating, by the one or more processors, using the custom performance model, fuel consumption for a planned flight of the aircraft.

Example 10. A system for assessing performance of an aircraft, the system comprising: a memory; and processing circuitry coupled to the memory and configured to: obtain flight data from one or more aircraft sensors, the flight data associated with a flight operation of an aircraft; extract from the flight data, one or more flight data indicators, wherein each of the one or more flight data indicators represent performance of the aircraft during one or more flights; correlate, by a machine learning model, the one or more flight data indicators with one or more operational factors; generate, by the machine learning model, a custom performance model for the aircraft based on the correlating of the one or more flight data indicators with the one or more operational factors; and output a performance factor for the aircraft based on the custom performance model.

Example 11. The system of example 10, wherein the machine learning model comprises a relational model.

Example 12. The system of example 10, wherein the performance factor comprises at least one of: estimated flight time of the aircraft, evaluation of fuel efficiency of the aircraft, identification of one or more safety risks of the aircraft, and analysis of operational trends of the aircraft.

Example 13. The system of example 10, wherein the performance factor forecasts potential aircraft performance issues based on current trends and the one or more operational factors.

Example 14. The system of example 10, wherein the one or more operational factors comprise one or more of a number of cycles, a type of landing, a type of airport, weather conditions experienced during flight, a load factor, or hours of flight.

Example 15. The system of example 10, the processing circuitry further configured to: perform an action related to the aircraft based on the performance factor.

Example 16. The system of example 15, wherein the action comprises scheduling maintenance of the aircraft.

Example 17. The system of example 10, the processing circuitry further configured to: generate, using the custom performance model, a flight plan; and upload the flight plan to a Flight Management System (FMS) of the aircraft.

Example 18. The system of example 10, the processing circuitry further configured to: estimate, using the custom performance model, fuel consumption for a planned flight of the aircraft.

Example 19. Non-transitory computer-readable storage media having instructions encoded thereon, the instructions configured to cause processing circuitry to: obtain flight data from one or more aircraft sensors, the flight data associated with a flight operation of an aircraft; extract from the flight data, one or more flight data indicators, wherein each of the one or more flight data indicators represent performance of the aircraft during one or more flights; correlate, by a machine learning model, the one or more flight data indicators with one or more operational factors; generate, by the machine learning model, a custom performance model for the aircraft based on the correlating of the one or more flight data indicators with the one or more operational factors; and output a performance factor for the aircraft based on the custom performance model.

Example 20. The non-transitory computer-readable storage media of example 19, wherein the machine learning model comprises a relational model.

The general discussion of the present disclosure provides a brief, general description of a suitable computing environment in which the present disclosure may be implemented. Any of the disclosed systems, processes, and/or graphical user interfaces may be executed by or implemented by a computing system consistent with or similar to that depicted and/or explained in the present disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure also may be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

One or more includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, but these elements should not be limited by these terms. Except where otherwise indicated, these terms are only used to distinguish one element from another. For example, a first contact could be termed a second contact, and, similarly, a second contact could be termed a first contact, without departing from the scope of the various described examples. The first contact and the second contact are both contacts but may not be the same contact.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In the present disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout the present disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

Various examples have been described. These and other examples are within the scope of the following claims.

What is claimed is:

1. A computer-implemented method for assessing performance of an aircraft, the computer-implemented method comprising:
obtaining, by one or more processors, flight data from one or more aircraft sensors, the flight data associated with a flight operation of an aircraft;
extracting, by the one or more processors, from the flight data, one or more flight data indicators, wherein each of the one or more flight data indicators represent performance of the aircraft during one or more flights;
correlating, by a machine learning model, the one or more flight data indicators with one or more operational factors;
generating, by the machine learning model, a custom performance model for the aircraft based on the correlating of the one or more flight data indicators with the one or more operational factors; and
outputting, by the one or more processors, a performance factor for the aircraft based on the custom performance model.

2. The computer-implemented method of claim 1, wherein the machine learning model comprises a relational model.

3. The computer-implemented method of claim 1, wherein the performance factor comprises at least one of: estimated flight time of the aircraft, evaluation of fuel efficiency of the aircraft, identification of one or more safety risks of the aircraft, and analysis of operational trends of the aircraft.

4. The computer-implemented method of claim 1, wherein the performance factor forecasts potential aircraft performance issues based on current trends and the one or more operational factors.

5. The computer-implemented method of claim 1, wherein the one or more operational factors comprise one or more of a number of cycles, a type of landing, a type of airport, weather conditions experienced during flight, a load factor, or hours of flight.

6. The computer-implemented method of claim 1, further comprising:
performing, by the one or more processors, an action related to the aircraft based on the performance factor.

7. The computer-implemented method of claim 6, wherein the action comprises scheduling maintenance of the aircraft.

8. The computer-implemented method of claim 1, further comprising:
generating, by the one or more processors, using the custom performance model, a flight plan; and
uploading the flight plan to a Flight Management System (FMS) of the aircraft.

9. The computer-implemented method of claim 1, further comprising:
estimating, by the one or more processors, using the custom performance model, fuel consumption for a planned flight of the aircraft.

10. A system for assessing performance of an aircraft, the system comprising:
a memory; and
processing circuitry coupled to the memory and configured to:
obtain flight data from one or more aircraft sensors, the flight data associated with a flight operation of an aircraft;
extract from the flight data, one or more flight data indicators, wherein each of the one or more flight data indicators represent performance of the aircraft during one or more flights;
correlate, by a machine learning model, the one or more flight data indicators with one or more operational factors;
generate, by the machine learning model, a custom performance model for the aircraft based on the correlating of the one or more flight data indicators with the one or more operational factors; and
output a performance factor for the aircraft based on the custom performance model.

11. The system of claim 10, wherein the machine learning model comprises a relational model.

12. The system of claim 10, wherein the performance factor comprises at least one of: estimated flight time of the aircraft, evaluation of fuel efficiency of the aircraft, identification of one or more safety risks of the aircraft, and analysis of operational trends of the aircraft.

13. The system of claim 10, wherein the performance factor forecasts potential aircraft performance issues based on current trends and the one or more operational factors.

14. The system of claim 10, wherein the one or more operational factors comprise one or more of a number of cycles, a type of landing, a type of airport, weather conditions experienced during flight, a load factor, or hours of flight.

15. The system of claim 10, the processing circuitry further configured to:
perform an action related to the aircraft based on the performance factor.

16. The system of claim 15, wherein the action comprises scheduling maintenance of the aircraft.

17. The system of claim 10, the processing circuitry further configured to:
generate, using the custom performance model, a flight plan; and
upload the flight plan to a Flight Management System (FMS) of the aircraft.

18. The system of claim 10, the processing circuitry further configured to:
estimate, using the custom performance model, fuel consumption for a planned flight of the aircraft.

19. Non-transitory computer-readable storage media having instructions encoded thereon, the instructions configured to cause processing circuitry to:
obtain flight data from one or more aircraft sensors, the flight data associated with a flight operation of an aircraft;
extract from the flight data, one or more flight data indicators, wherein each of the one or more flight data indicators represent performance of the aircraft during one or more flights;
correlate, by a machine learning model, the one or more flight data indicators with one or more operational factors;
generate, by the machine learning model, a custom performance model for the aircraft based on the correlating of the one or more flight data indicators with the one or more operational factors; and
output a performance factor for the aircraft based on the custom performance model.

20. The non-transitory computer-readable storage media of claim 19, wherein the machine learning model comprises a relational model.
